(19) United States
(12) Patent Application Publication
(10) Pub. No.: US 2007/0132594 A1
(43) Pub. Date: Jun. 14, 2007

(54) Electronic device and fabrication method thereof

(75) Inventor: Toshimichi Masuta, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/604,291

(22) Filed: Nov. 27, 2006

(30) Foreign Application Priority Data
Nov. 29, 2005 (JP) 2005-344240

(51) Int. Cl. G08B 13/14; B31B 1/60; H01Q 17/00

(52) U.S. Cl. 340/572.8; 340/572.7; 29/601; 156/60

(57) ABSTRACT

A technique able to fabricate an inlet for an electronic tag having a desired communication characteristic is provided in an easy and less expensive manner. A matching circuit pattern for which a high dimensional accuracy is required and antenna patterns not requiring a high dimensional accuracy are formed in separate processes using separate materials. A structure comprising the matching circuit pattern, a chip and an insulating film is bonded to the antenna patterns with use of, for example, a resinous adhesive in such a manner that the insulating film is opposed to the antenna patterns, whereby the structure and the antenna patterns are electrically connected in proximity to each other through capacitances.

### CROSS-REFERENCE TO RELATED APPLICATION

The present application claims priority from Japanese patent application No. 2005-344240 filed on Nov. 29, 2005, the content of which is hereby incorporated by reference into this application.

### BACKGROUND OF THE INVENTION

The present invention relates to an electronic device and a fabrication method thereof. Particularly, the present invention is concerned with a technique applicable effectively to the fabrication of an inlet for a non-contact type electronic tag.

In Japanese Unexamined Patent Publication No. 2001-102837 (Patent Literature 1) there is disclosed a technique wherein capacitance adjusting means having a conductor on an insulator, the conductor having the same pattern as an antenna pattern in part of an antenna, is superimposed on and bonded to a non-contact type data transmitter/receiver, thereby easily affording a non-contact type data transmitter/receiver with adjusted capacitance value.

In Japanese Unexamined Patent Publication No. 2004-362190 (Patent Literature 2) wherein there are used an IC chip and two upper and lower rectangular antennas, the IC chip having two input and output terminals capable of being taken out from a surface and a back surface, respectively, of the chip, thereby affording a dipole type non-contact IC tag which is small in thickness, low in cost, high in reliability and superior in communication characteristics.

In Japanese Unexamined Patent Publication No. 2004-213582 (Patent Literature 3) there is disclosed a technique wherein plural tags with antenna are superimposed together to afford a tag capable of conforming to plural standards.

Patent Literature 1:

Japanese Unexampled Patent Publication No. 2001-102837

Patent Literature 2:

Japanese Unexamined Patent Publication No. 2004-362190

Patent Literature 3:

Japanese Unexamined Patent Publication No. 2004-213582

### SUMMARY OF THE INVENTION

A non-contact type electronic tag is a tag wherein a desired data stored in a memory circuit formed within a semiconductor chip and is read using a microwave. This tag has a structure such that the semiconductor chip is mounted in an antenna constituted by a lead frame.

Since data are stored in a memory circuit formed within a semiconductor chip, the electronic tag is advantageous in that a large capacity of data can be stored in comparison with a tag which utilizes a bar code. The electronic tag is also advantageous in that the data stored in the memory circuit are difficult to altered illegally in comparison with data stored in a bar code.

As shown in FIG. 36, an inlet 100 for an electronic tag is formed for example by connecting a semiconductor chip 103 to an electrically conductive antenna pattern 102 formed on an antenna base 101. FIG. 37 is a circuit diagram of the electronic tag inlet 100. As the antenna pattern 102 there is used a dipole antenna for example. An impedance value of the antenna pattern 102 as the dipole antenna and that of the semiconductor chip 103 are in many cases quite different from each other. A solution to this problem may be such that a matching circuit 104 for impedance matching is connected electrically between the antenna pattern 102 and the semiconductor chip 103. The matching circuit 104 can be formed by both inductance component and capacitance component generated by improving the shape of a slit pattern 105 which is formed in the antenna pattern 102 near the mounted position of the semiconductor chip 103.

In the structure shown in FIG. 36, both antenna pattern 102 and slit pattern 105 for impedance matching are formed on the same antenna base 101. As noted above, the electronic tag inlet 100 makes communication using a microwave. Therefore, a slight dimensional error of the slit pattern 105 causes a change in impedance of the matching circuit 105, with consequent deterioration in communication characteristic of the electronic tag inlet 100 and shortening of the communication distance.

Moreover, the semiconductor chip 103 is connected to the antenna pattern 102 in a very small area, so in order to obtain a desired impedance value of the matching circuit 104, a high dimensional accuracy is required of the antenna pattern 102 including the slit pattern 105. Therefore, it is necessary that the antenna base 101 including the antenna pattern 102 be made of an expensive material high in dimensional accuracy. On the other hand, the antenna pattern 102 functions as an antenna if the electrically conductive material which forms the antenna pattern projects into space. Therefore, if attention is paid to the function as an antenna, the antenna base 101 including the antenna pattern 102 is not required to have a high dimensional accuracy. That is, the portion of the antenna base 101 for which a high dimensional accuracy is required is only a very small portion where the slit pattern 105 is formed. It is wasteful to form the whole of the antenna base 101 with use of an expensive material of a high dimensional accuracy for only such a very small portion. If the antenna base 101 is formed using separate materials for the portion where the slit pattern 105 is formed and for the other portion, it is possible to reduce the material cost. However, a work for connecting the two by pressure bonding or the like becomes necessary, but this is difficult technically and an increase in the number of steps results. Consequently, it becomes difficult to attain the reduction of cost.

If there is adopted a structure wherein the antenna base 101 including the antenna pattern 102 is formed integrally, it is necessary to re-check equipment throughout all the steps in order to fabricate an electronic tag inlet 100 of different specifications including size, shape and communication characteristic. This causes an increase in the fabrication cost of the electronic tag inlet 100 and eventually it becomes difficult to meet a market demand such as various-kinds small-lot production.

It is an object of the present invention to provide a technique able to fabricate an inlet for an electronic tag having a desired communication characteristic easily and inexpensively.

The following is an outline of typical modes of the present invention as disclosed herein.

(1) In one aspect of the present invention there is provided an electronic device comprising:

a semiconductor chip;

an antenna formed by a first conductive film;

a matching circuit formed by a second conductive film having a slit one end of which extends to an outer edge of the film, the matching circuit having the semiconductor chip mounted thereon and being connected electrically to the semiconductor chip and connected in proximity to the antenna through a first insulating film; and

resin which seals the semiconductor chip.

(2) In another aspect of the present invention there is provided an electronic device comprising:

a semiconductor chip;

a matching circuit formed by a second conductive film having a slit one end of which extends to an outer edge of the film, the matching circuit having the semiconductor chip mounted thereon and being connected electrically to the semiconductor chip and connected in proximity to an antenna through a first insulating film; and

resin which seals the semiconductor chip.

(3) In a further aspect of the present invention there is provided a method of fabricating an electronic device, the electronic device comprising a semiconductor chip, an antenna formed by a first conductive film, and a matching circuit formed by a second conductive film having a slit one end of which extends to an outer edge of the film, the matching circuit having the semiconductor chip mounted thereon and being connected electrically to the semiconductor chip and connected in proximity to the antenna through a first insulating film, the method comprising the steps of:

(a) providing the antenna formed on a first insulator;

(b) providing the first insulating film, the first insulating film having a plurality of the matching circuits on a main surface thereof;

(c) mounting the semiconductor chip on each of the plural matching circuits and connecting the semiconductor chip and each of the matching circuits electrically with each other;

(d) sealing the semiconductor chip on each of the matching circuits with resin;

(e) after the steps (a) to (d), cutting the first insulating film to divide the plural matching circuits into individual circuits; and

(f) affixing the individual matching circuits to the antenna in such a manner that the first insulating film and the antenna are opposed to each other.

(4) In a still further aspect of the present invention there is provided a method of fabricating an electronic device, the electronic device comprising a semiconductor chip and a matching circuit formed by a second conductive film having a slit one end of which extends to an outer edge of the film, the matching circuit having the semiconductor chip mounted thereon and being connected electrically to the semiconductor chip and connected in proximity to an antenna through a first insulating film, the method comprising the steps of:

(a) providing the first insulating film, the first insulating film having a plurality of the matching circuits on a main surface thereof;

(b) mounting the semiconductor chip on each of the plural matching circuits and connecting the semiconductor chip and each of the matching circuits electrically with each other;

(c) sealing the semiconductor chip on each of the matching circuits with resin; and

(d) after the steps (a) to (c), shipping the plural matching circuits, the step (d) including the following step (d1) or (d2):

(d1) cutting the first insulating film to divide the plural matching circuits into individual circuits and shipping the individual circuits, or

(d2) shipping the plural matching circuits without cutting the first insulating film into individual matching circuits.

The following is a brief description of effects obtained by the typical modes of the present invention as disclosed herein.

(1) Since the matching circuit pattern (matching circuit) and the antenna pattern are bonded together by an adhesive through an insulating film interposed therebetween, it is possible to effect bonding of both patterns easily. Consequently, the inlet formed by bonding both matching circuit pattern and antenna pattern can be fabricated in a short period.

(2) Since the matching circuit pattern (matching circuit) for which a high dimensional accuracy is required and the antenna pattern not requiring a high dimensional accuracy are formed in separate steps using separate materials, it is possible to reduce the fabrication cost of the inlet which is formed by bonding both matching circuit pattern and antenna pattern.

### BRIEF DESCRIPTION OF THE DRAWINGS

FIG. 1 is a flow chart explaining a process for fabrication of an electronic tag inlet as an electronic device according to a first embodiment of the present invention;

FIG. 2 is a plan view showing a part of an elongated insulating film used in fabricating the electronic tag inlet as the electronic device of the first embodiment;

FIG. 3 is a plan view showing on a larger scale a part of the elongated insulating film of FIG. 2;

FIG. 4 is a plan view of a semiconductor chip mounted on the electronic tag inlet as the electronic device of the first embodiment;

FIG. 5 is a sectional view of a bump electrode and the vicinity thereof formed on a main surface of the semiconductor chip of FIG. 4;

FIG. 6 is a sectional view of a dummy bump electrode and the vicinity thereof formed on the main surface of the semiconductor chip of FIG. 4;

FIG. 7 is a schematic diagram of an inner lead bonder, showing a part (a step of interconnecting the semiconductor chip and a matching circuit pattern) of the fabrication process for the electronic tag inlet as the electronic device of the first embodiment;

FIG. 8 is a schematic diagram showing on a larger scale a principal portion of the inner lead bonder of FIG. 7;

FIG. 9 is an enlarged plan view of a principal portion of the insulating film, showing a part (the step of interconnecting the semiconductor chip and the matching circuit pattern) of the fabrication process for the electronic tag inlet as the electronic device of the first embodiment;

FIG. 10 is an enlarged plan view of a principal portion of the insulating film, showing a part (the step of interconnecting the semiconductor chip and the matching circuit pattern) of the fabrication process for the electronic tag inlet as the electronic device of the first embodiment;

FIG. 11 is an enlarged plan view of a principal portion of an insulating film, showing a part (a step of interconnecting a semiconductor chip and an antenna) of an electronic tag inlet fabricating process as compared with the fabrication process for the electronic tag inlet as the electronic device of the first embodiment;

FIG. 12 is a schematic diagram showing a part (a step of sealing the semiconductor chip with resin) of the fabrication process for the electronic tag inlet as the electronic device of the first embodiment;

FIG. 13 is an enlarged plan view of a principal portion of the insulating film, showing a part (the step of sealing the semiconductor chip with resin) of the fabrication process for the electronic tag inlet as the electronic device of the first embodiment;

FIG. 14 is a side view showing a wound-up state onto a reel of the insulating film used in fabrication of the electronic tag inlet as the electronic device of the first embodiment;

FIG. 15 is a plan view showing a part of the elongated insulating film used in fabrication of the electronic tag inlet as the electronic device of the first embodiment;

FIG. 16 is an explanatory diagram of a communication characteristic test in the fabrication process for the electronic tag inlet as the electronic device of the first embodiment;

FIG. 17 is a plan view of a principal portion in the fabrication process for the electronic tag inlet as the electronic device of the first embodiment;

FIG. 18 is a plan view showing a part of an elongated insulating film used in fabrication of an antenna in the electronic tag inlet as the electronic device of the first embodiment;

FIG. 19 is a plan view showing on a larger scale a part of the insulating film of FIG. 18;

FIG. 20 is a plan view of a principal portion in the fabrication process for the electronic tag inlet as the electronic device of the first embodiment;

FIG. 21 is a sectional view of a principal portion in the fabrication process for the electronic tag inlet as the electronic device of the first embodiment;

FIG. 22 is an explanatory diagram showing a state of electric connection of constituent members of the electronic tag inlet as the electronic device of the first embodiment;

FIG. 23 is a plan view of a principal portion in the fabrication process for the electronic tag inlet as the electronic device of the first embodiment;

FIG. 24 is a perspective view of a principal portion of a label seal used in fabrication of an electronic device according to a second embodiment of the present invention;

FIG. 25 is a side view of a principal portion of the label seal used in fabrication of the electronic device of the second embodiment;

FIG. 26 is a plan view of a principal portion of the label seal used in fabrication of the electronic device of the second embodiment;

FIG. 27 is a plan view of the label seal used in fabrication of the electronic device of the second embodiment;

FIG. 28 is a plan view in a fabrication process of an electronic device according to a third embodiment of the present invention;

FIG. 29 is a plan view of the electronic device of the third embodiment;

FIG. 30 is a plan view of the electronic device of the third embodiment;

FIG. 31 is a plan view of the electronic device of the third embodiment;

FIG. 32 is a plan view of the electronic device of the third embodiment;

FIG. 33 is a plan view of an electronic device according to a fourth embodiment of the present invention;

FIG. 34 is a plan view of the electronic device of the fourth embodiment;

FIG. 35 is a perspective view of the electronic device of the fourth embodiment;

FIG. 36 is a plan view of an electronic tag inlet as an electronic device which the present inventors have studied; and

FIG. 37 is a circuit diagram of the electronic tag inlet as the electronic device which the present inventors have studied.

### DETAILED DESCRIPTION OF THE PREFERRED EMBODIMENTS

Before describing the present invention in detail, a description will be given below about the meanings of terms as used herein.

By electronic tag is meant a principal electronic part of an RFID (Radio Frequency IDentification) system or EPC (Electronic Product Code) system, with electronic information, communication function and data rewrite function being generally incorporated in a chip of several millimeters or less (including a larger case). Using a radio wave or an electromagnetic wave, the electronic tag communicates with reader. The electronic tag is also called a radio tag or IC tag, and by attaching it to a commodity it becomes possible to effect a complicated information processing of a high grade in comparison with the bar code. There also exists a tag which utilizes a non-contact power transmission technique from an antenna side (the exterior or the interior of a chip) and which thereby can be used semipermanently without a cell. There are various shapes of tags such as, for example, label, card, coin, and stick types, from which a suitable one is selected according to the purpose of use. The communication distance ranges from several millimeters to several meters and a suitable communication distance is selected also according to the purpose of use.

By inlet (generally a composite of RFID chip and antenna, provided there also is one free of antenna or one with antenna deposited on a chip, and thus one free of antenna is also included in the inlet as the case may be) is meant a basic product form in a mounted state of an IC chip on a metal coil (antenna). The metal coil and the IC chip are usually in an exposed state, provided there also is a case where they are sealed.

By proximity connection or being connected in proximity is meant to attain an electric conduction without direct joining of plural electronic components. For example, from the standpoint of an electric circuit, it indicates a state in which electronic parts are connected together electrically by a high-frequency operation of the circuit through capacitors or the like.

Where required for convenience sake, the following embodiments will each be described in a divided manner into plural sections or embodiments, but unless otherwise mentioned, they are not unrelated to each other but are in a relation such that one is a modification or a detailed or supplementary explanation of part or the whole of the other.

In the following embodiments, when reference is made to the number of elements (including the number, numerical value, quantity and range), no limitation is made to the number referred to, but numerals above and below the number referred to will do as well unless otherwise mentioned and except the case where it is basically evident that limitation is made to the number referred to.

In the following embodiments it goes without saying that their components (including constituent steps) are not always essential unless otherwise mentioned and except the case where they are considered essential basically clearly. Moreover, it goes without saying that when there is described “consisting of A or comprising A” with respect to a constituent element or the line in the following embodiments, other elements are not excluded except the case where it is clearly shown that limitation is made to only the element in question.

Likewise, in the following embodiments, when reference is made to the shape and positional relation of constituent elements, those substantially similar or closely similar to that shape, etc. are also included unless otherwise mentioned and except the case where a negative answer is evident basically. This is also true of the foregoing numerical value and range.

In all of the drawings for illustrating the following embodiments, portions having the same functions are identified by like reference numerals and repeated explanations thereof will be omitted.

Further, in the drawings related to the following embodiments, even a plan view may be hatched partially to make it easier to see.

Embodiments of the present invention will be described in detail hereinunder with reference to the drawings.

### First Embodiment

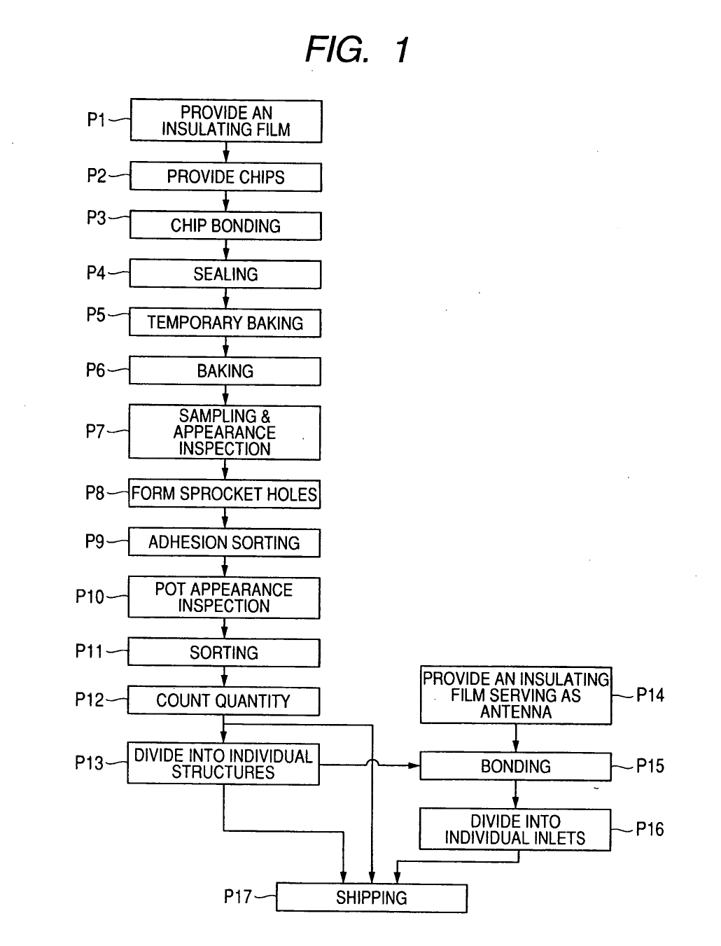

An electronic device according to a first embodiment of the present invention is an inlet for an electronic tag. The inlet of this first embodiment, as well as a fabrication method thereof, will be described with reference to FIGS. 1 to 22. FIG. 1 is a flow chart explaining an inlet fabrication process.

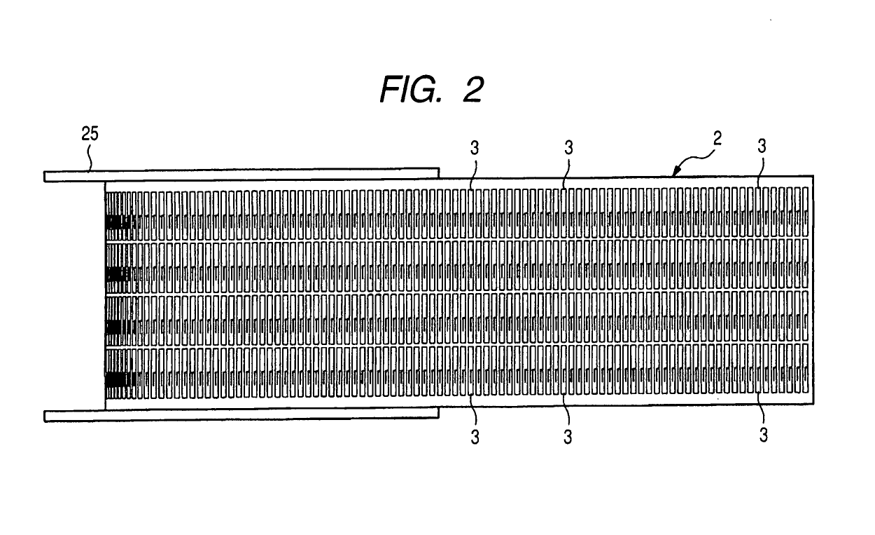

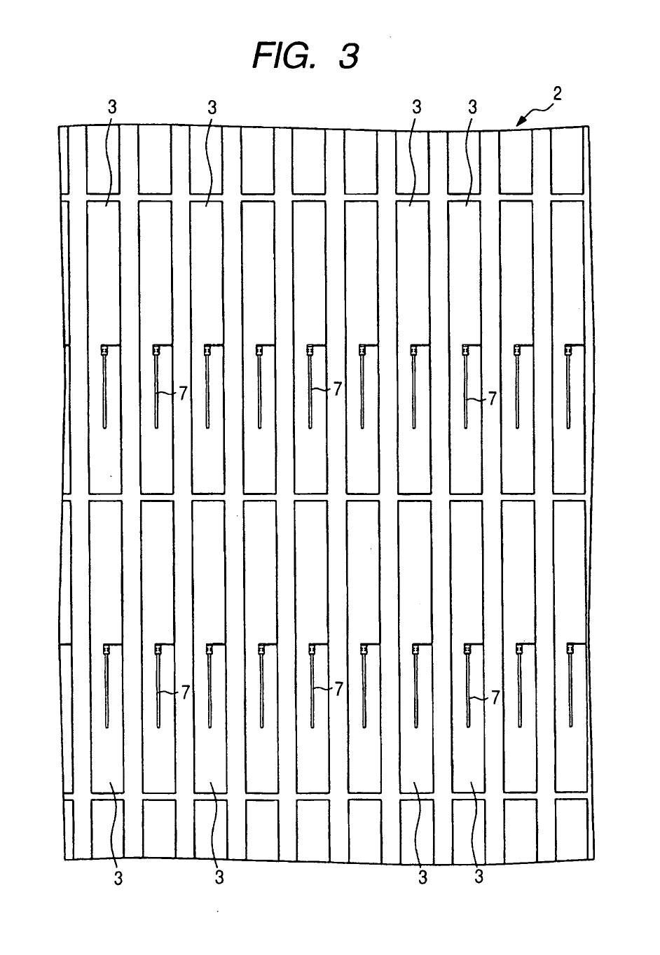

First, an insulating film to be used in fabrication of the inlet of this first embodiment is provided (step P1). FIG. 2 is a plan view showing an insulating film (first insulating film) 2 used in fabricating the inlet of this first embodiment and FIG. 3 is a plan view showing on a larger scale a part of FIG. 2.

As shown in FIG. 2, the insulating film 2, which is like a continuous tape, is loaded to an inlet fabrication process while being wound up onto a reel 25. A large number of matching circuit patterns (matching circuits) 3 are formed beforehand at predetermined intervals on one surface of the insulating film 2. The matching circuit patterns 3 are formed for example by bonding Al foil (second conductive film) of about 20 μm in thickness to one surface of the insulating film 2 and etching the Al foil into the shape of the matching circuit patterns 3. At this time, a slit 7 and leads to be described later are formed in each of the matching circuit patterns 3. The impedance of each matching circuit pattern 3 is determined by the shape of the slit 7 and therefore it is necessary that the machining for the slit 7 be done with a high dimensional accuracy. For example, the matching circuit patterns 3 are formed in four rows in the direction in which the insulating film 2 wound on the reel 25 is drawn out. The insulating film 2, which conforms to the standard of film carrier tapes, is for example a polyethylene naphthalate film having a thickness of 25 μm. By thus forming the matching circuit patterns 3 with use of Al foil and forming the insulating film 2 from polyethylene naphthalate, it is possible to reduce the inlet material cost in comparison with forming the matching circuit patterns 3 from Cu foil and forming the insulating film from polyimide resin.

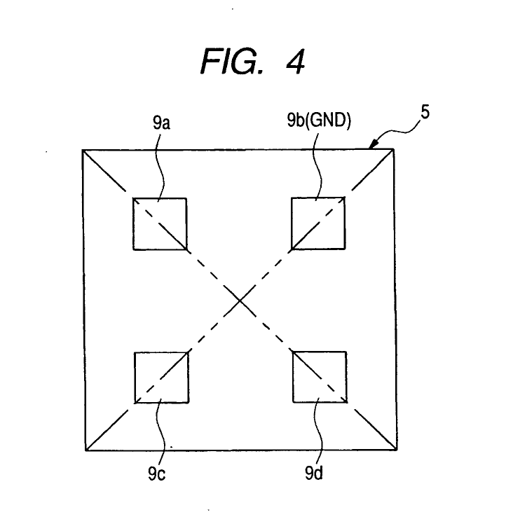

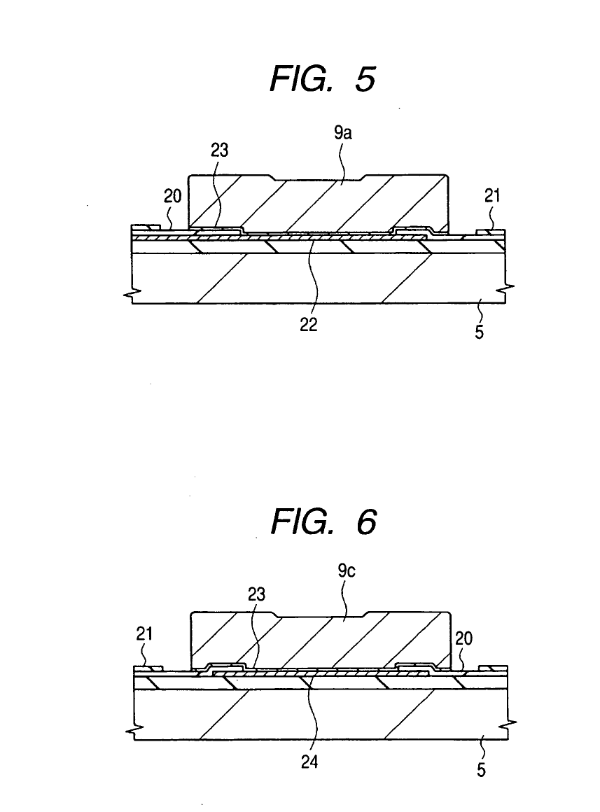

Next, semiconductor chips (hereinafter referred to simply as chips) 5 to be mounted on the matching circuit patterns 3 are provided (step P2). In this connection, FIG. 4 is a plan view showing a layout of four Au bumps 9a, 9b, 9c and 9d formed on a main surface of each chip 5, FIG. 5 is an enlarged sectional view of the vicinity of the Au bump 9a, and FIG. 6 is an enlarged sectional view the vicinity of the Au bump 9c.

Each chip 5 is constituted by a single crystal silicon substrate having a thickness of about 0.15 mm and a circuit comprising rectifier, transmitter, clock extractor, selector, counter and ROM is formed on a main surface of the chip. The ROM has a storage capacity of 128 bits and can store a larger capacity of data in comparison with such a storage medium as a bar code. There also is an advantage that the data stored in the ROM are difficult to be altered illegally in comparison with data stored in a bar code.

Four Au bumps 9a, 9b, 9c and 9d are formed on the main surface of each chip 5 with the above circuit formed thereon. The four Au bumps 9a to 9d are positioned on a pair of imaginary diagonal lines indicated by dash-double dot lines in FIG. 4 so as to be equidistant from a point of intersection of the diagonal lines (the center of the main surface of the chip 5). The Au bumps 9a to 9d are formed for example by electrolytic plating and their height is, say, 15 μm or so.

The layout of the Au bumps 9a to 9d is not limited to the one shown in FIG. 4, but it is preferable to adopt a layout easy to take balance against a load in chip connection. For example, in a planar layout, it is preferable to arrange them in such a manner that a polygon formed by tangent lines of Au bumps surrounds the center of the chip.

Of the four Au bumps 9a, 9b, 9c and 9d, for example the Au bump 9a constitutes an input terminal of the foregoing circuit and the Au bump 9b constitutes a GND terminal. The remaining two Au bumps 9c and 9d constitute dummy bumps not connected to the foregoing circuit.

As shown in FIG. 5, the Au bump 9a which constitutes the input terminal of the circuit is formed on a top-layer metal wiring 22, the top-layer metal wiring 22 being exposed by etching a passivation film 20 and polyimide resin 21 which cover the main surface of the chip 5. Between the Au bump 9a and the top-layer metal wiring 22 is formed a barrier metal film 23 to enhance the adhesion between the two. For example, the passivation film 20 is formed by a laminate film of both silicon oxide film and silicon nitride film, while the top-layer metal wiring 22 is formed by Al alloy film. The barrier metal film 23 is formed for example by a laminate film of both Ti film which is high in adhesion to the Al alloy film and Pd film which is high adhesion to the Au bump 9a. Though not shown, the connection between the Au bump 9b which constitutes a GND terminal of the circuit and the top-layer metal wiring 22 is also of the same construction as above. On the other hand, as shown in FIG. 6, the Au bump 9c (and 9d) which constitutes a dummy bump is connected to a metal layer 24 formed in the same wiring layer as the metal wiring 22, but the metal layer 24 is not connected to the above circuit.

For forming each chip 5, first a wafering process is performed to form semiconductor elements, integrated circuits and the Au bumps 9a to 9d on a main surface of a wafer-like semiconductor substrate (simply “substrate” hereinafter). Then, the wafer-like substrate is divided chip by chip by dicing to form each chip 5.

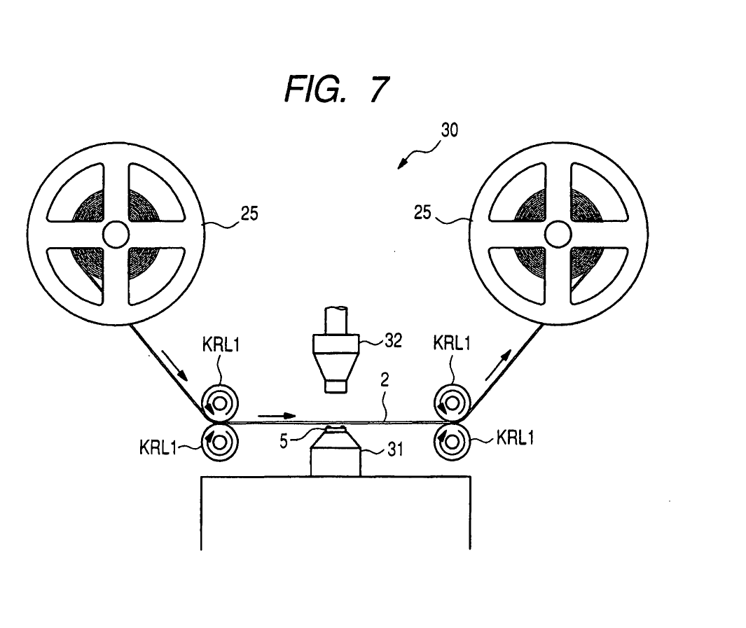

Next, as shown in FIG. 7, reels 25 are loaded to an inner lead bonder 30 provided with a bonding stage 31 and a bonding tool 32 and the chip 5 is connected to a matching circuit pattern 3 while moving the insulating film 2 along an upper surface of the bonding stage 31 (step P3).

As to driving rollers KRL1 for moving the insulating film 2, two such rollers of the same size and rotational speed are used in a pair and the insulating film 2 is sandwiched in between two driving rollers KRL1 and is moved with a frictional force. Four driving rollers KRL1 shown in FIG. 7 are of the same standard. By adopting such a method for moving the insulating film 2, even a thin insulating film 2 can be handled and can be conveyed at high speed with little damage thereto. The driving rollers KRL1 operate with power provided from a pulse motor not shown in FIG. 7.

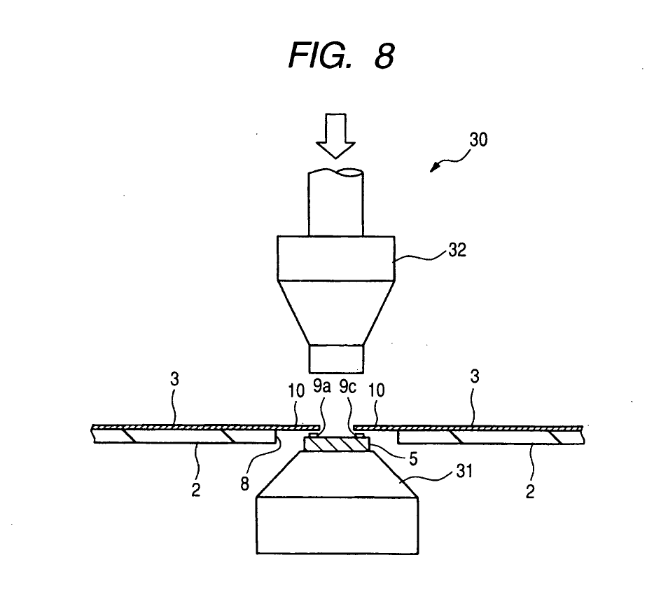

Each chip 5 is connected to a matching circuit pattern 3 in the following manner. As shown in FIG. 8 (an enlarged view of a principal portion of FIG. 7), the chip 5 is mounted on the bonding stage 31 heated to about 80° C., then a device hole 8 of the insulating film 2 is positioned just above the chip 5, and thereafter the bonding tool 32 heated to about 350° C. is pushed against upper surfaces of leads 10 projecting inside the device hole 8, thereby causing the Au bumps (9a to 9d) and the leads 10 to come into contact with each other. At this time, by applying predetermined ultrasonic wave and load to the bonding tool 32 for about 0.2 seconds there is formed an Au/Al bond at interfaces between the leads 10 and the Au bumps (9a to 9d), whereby the Au bumps (9a to 9d) and the leads 10 are bonded to each other.

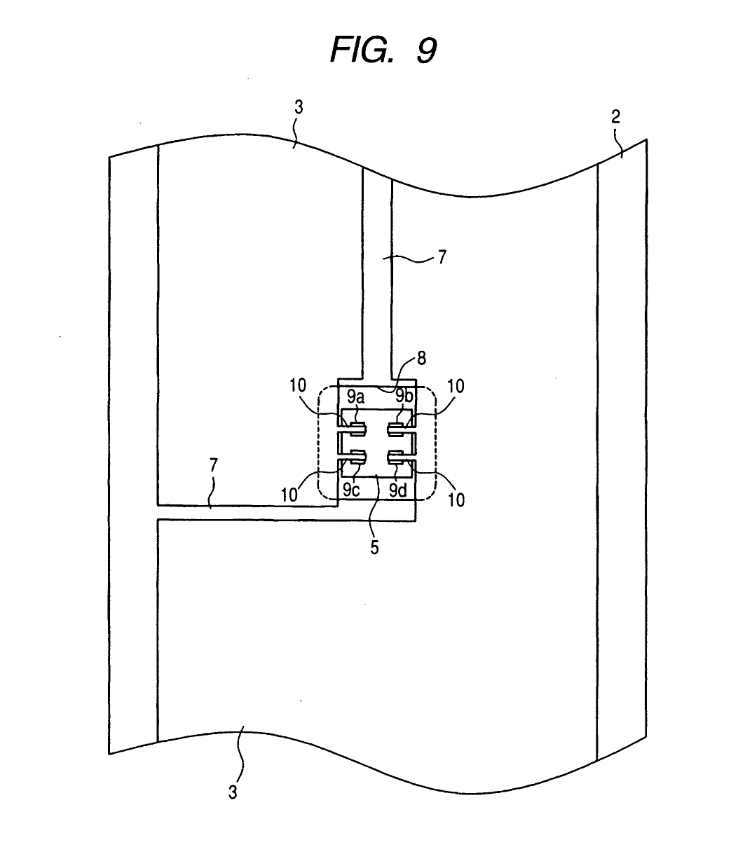

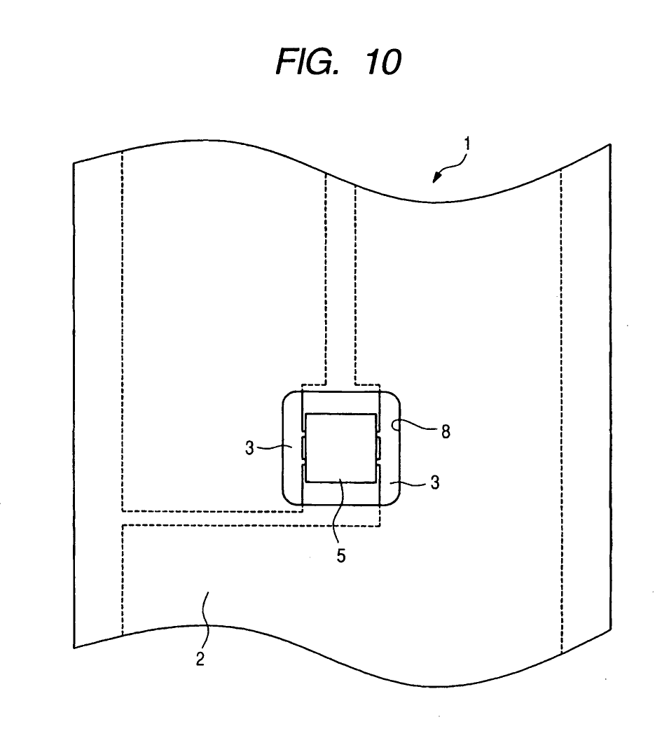

FIGS. 9 and 10 are plan views showing on a larger scale the vicinity of a central portion of the matching circuit pattern 3 with the slit 7 formed therein, of which FIG. 9 shows a surface side of the matching circuit pattern 3 and FIG. 10 shows a back surface side of the same pattern.

As shown in the figures, the device hole 8 is formed halfway of the slit 7 by punching a part of the insulating film 2. The chip 5 is disposed centrally of the device hole 8. For example, the device hole 8 is 0.8 mm long by 0.8 mm wide and the chip 5 is 0.48 mm long by 0.48 mm wide. The leads 10 are formed integrally with the matching circuit pattern 3 and one ends thereof extend inside the device hole 8. Of the four leads 10, two leads 10 extend inside the device hole 8 from one of bisected matching circuit patterns 3 resulting from bisection by the slit 7 and are connected electrically to the Au bumps 9a and 9c of the chip 5. The remaining two leads 10 extend inside the device hole 8 from the other matching circuit pattern 3 and are connected electrically to the Au bumps 9b and 9d of the chip 5.

In this first embodiment, as described above, the Au bumps 9a, 9b which constitute circuit terminals and the dummy Au bumps 9c, 9d are provided on the main surface of the chip 5 and these four Au bumps 9a, 9b, 9c and 9d are connected to the leads 10 of the matching circuit pattern 3. According to this construction, an effective area of contact between the Au bumps and the leads 10 becomes large in comparison with the case where only the two Au bumps 9a and 9b connected to the circuit are connected to the leads 10, so that the bonding strength between the Au bumps and the leads 10, i.e., the connection reliability between the two, is improved. By arranging the four Au bumps 9a, 9b, 9c and 9d on the main surface of the chip 5 in such a layout as shown in FIG. 4, there is no fear of tilting of the chip 5 relative to the insulating film 2 at the time of connecting the leads 10 to the Au bumps 9a, 9b, 9c and 9d. Consequently, the chip 5 can be sealed positively with potting resin 4, whereby the fabrication yield of the inlet of this first embodiment is improved.

Next, another chip 5 is placed on the bonding stage 31 and the same operations as above are performed to connect the chip to another matching circuit pattern 3. Subsequently, by repeating the same operations as above, chips 5 are connected to all the matching circuit patterns 3 formed on the insulating film 2. The insulating film 2 for which the work of interconnecting the chips 5 and the matching circuit patterns 3 has been completed is conveyed to the next resin sealing step in a wound-up state thereof onto a reel 25.

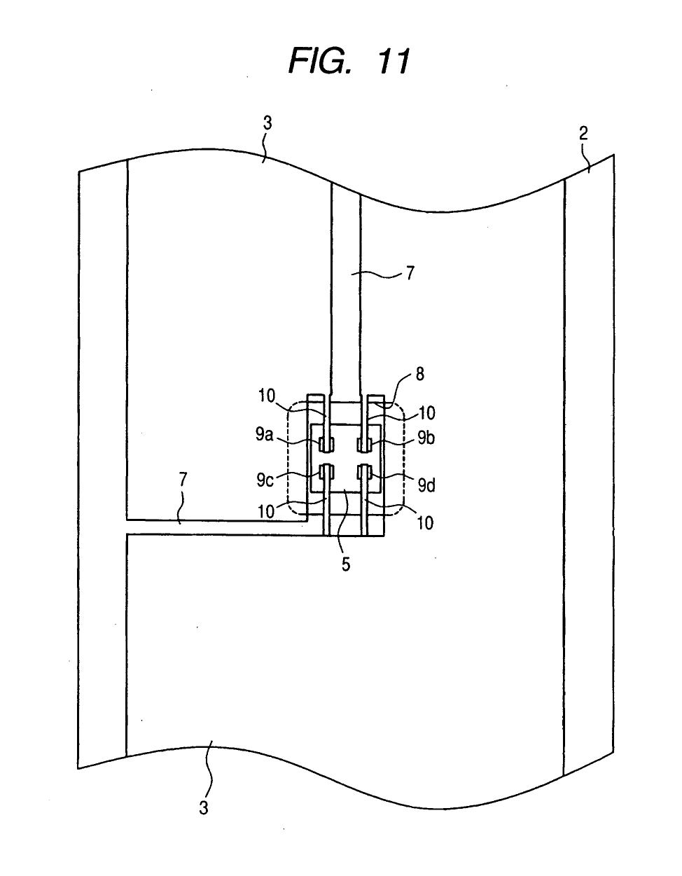

For improving the connection reliability between the Au bumps (9a to 9d) and the leads 10 it is preferable that the four leads 10 be extended in a direction perpendicular to the long-side direction of the matching circuit pattern 3, as shown in FIG. 9. In case of the four leads 10 being extended in parallel with the long-side direction of the matching circuit pattern 3, as shown in FIG. 11, a strong tensile stress acts on the connections between the Au bumps (9a to 9d) and the leads 10 when bending the completed inlet, with a consequent fear of deterioration of the connection reliability between the two.

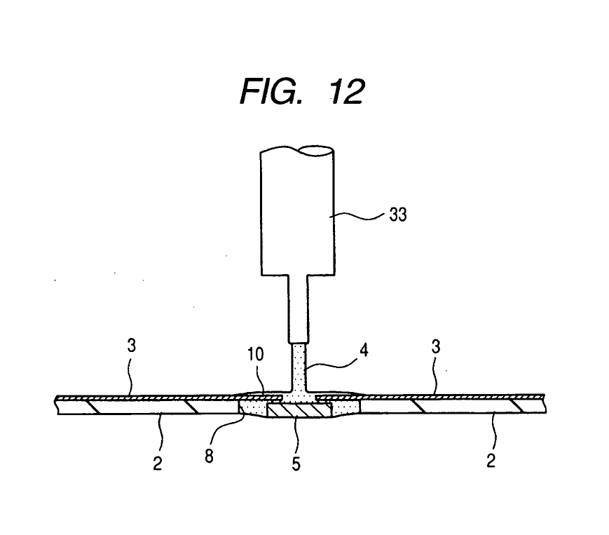

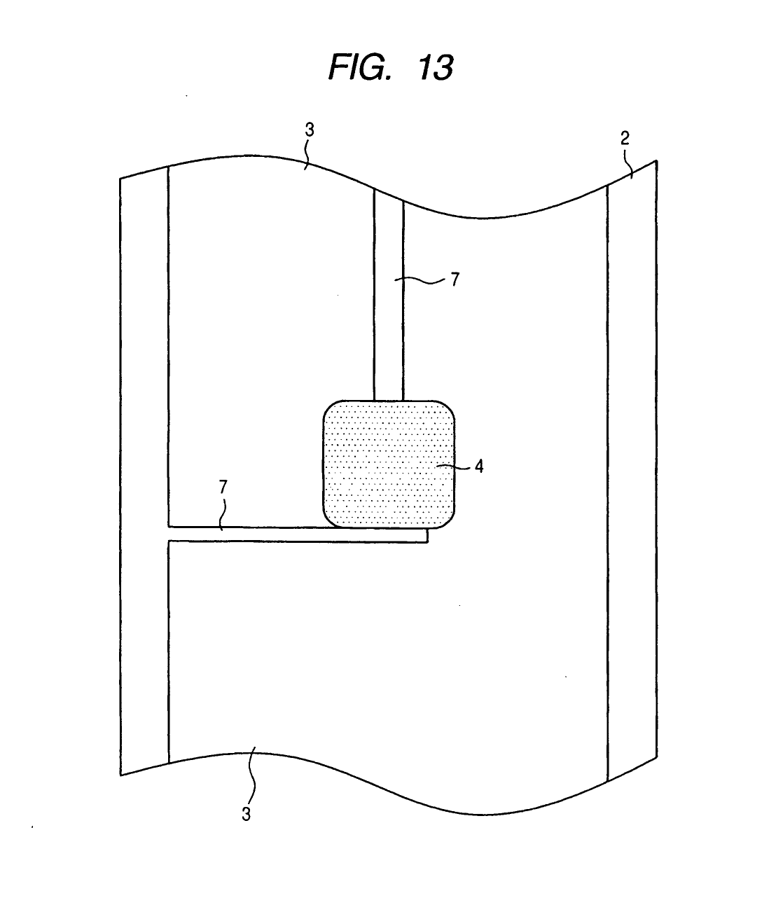

In the resin sealing step for the chip 5, as shown in FIGS. 12 and 13, potting resin 4 is fed using a dispenser 33 or the like to an upper surface and side faces of the chip 5 mounted inside the device hole 8 (step P4).

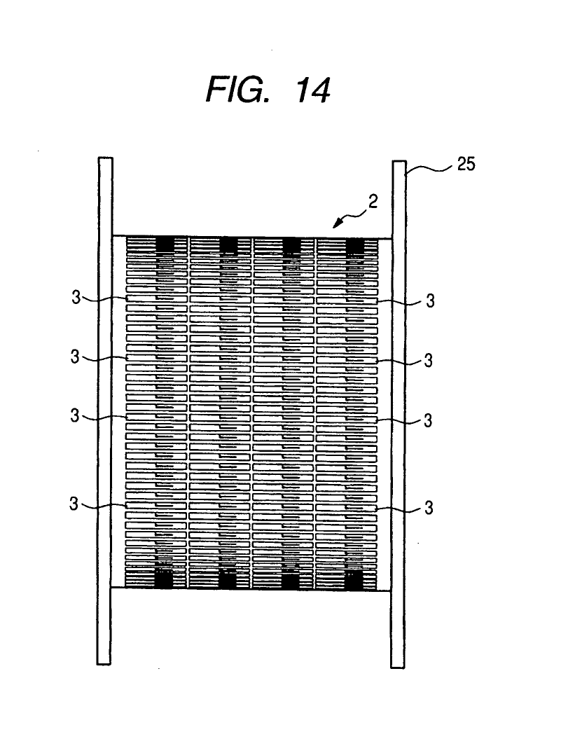

Next, within a heating furnace installed in a continuous assembling machine, a temporary baking treatment is applied to the potting resin at a temperature of about 120° C. (step P5). The insulating film 2 after the supply of the potting resin 4 and the temporary baking treatment is then conveyed to a heating furnace for a baking treatment in a wound-up state onto the reel 25, as shown in FIG. 14 and is subjected to a baking treatment at about 120° C. (step P6).

The insulating film 2 after completion of the baking treatment is then conveyed to the next step in a wound-up state onto the reel 25. In this step, sampling and appearance inspection are conducted for the structure wherein the chip 5 mounted on the matching circuit pattern 3 has been sealed with the potting resin 4. It is not that the appearance inspection is performed for all the structures, but is performed for a predetermined number of structures sampled at random (step P7). More specifically, when a defective appearance is found out, a portion inconvenient to the fabrication of the inlet of this first embodiment is specified with respect to the fabrication equipment and materials used up to the step P6 on the basis of the state of the defective appearance and is fed back to the subsequent inlet fabrication, thereby preventing the occurrence of any further inconvenience. The defective appearance as referred to herein includes one or more of adhesion of a foreign matter to any of the structures, flaw of any of the structures, defective sealing (deficient wet) of the potting resin 4, damage such as chipping of the chip 5, and an undesirable deformation of any of the structures.

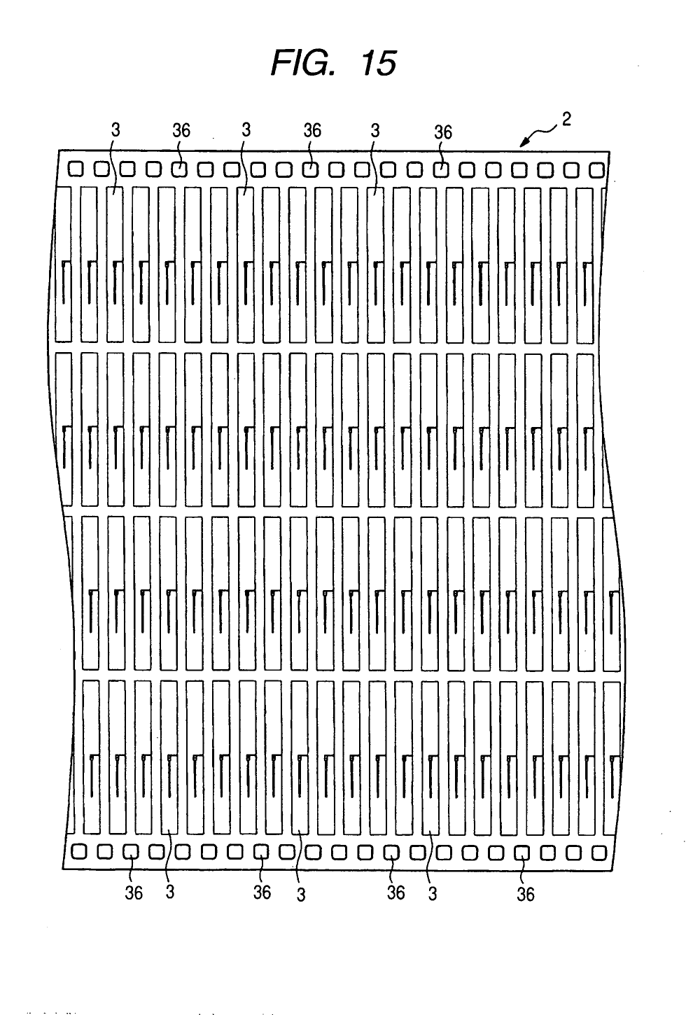

Next, where required in any of subsequent steps, such sprocket holes 36 for conveyance of the insulating film 2 as shown in FIG. 15 are formed at predetermined intervals in both side portions of the insulating film 2 (step P8). The sprocket holes 36 can be formed by punching a part of the insulating film 2. On the other hand, in the case where such sprocket holes 36 are not formed, it is possible to reduce the cost required for formation of the sprocket holes 36 (about one yen is required for forming a set (two) of sprocket holes in both ends of the insulating film 2).

Next, each of the structures formed from both matching circuit pattern 3 and chip 5 is subjected successively to communication characteristic test (step P9), appearance inspection of the potting resin 4 (see FIG. 13) (step P1), and sorting of non-defective, or conforming, products (step P11) after going through step P10.

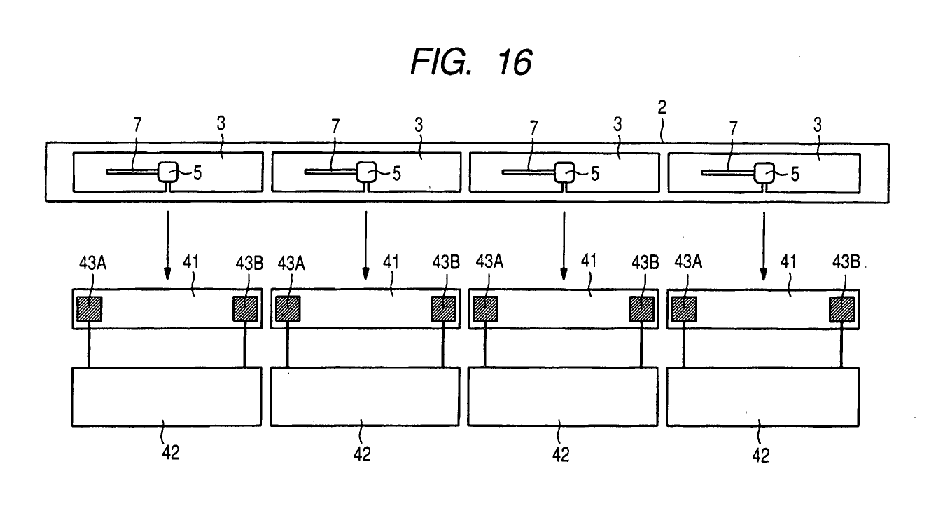

FIG. 16 is an explanatory diagram of the communication characteristic test of step P9. As noted earlier, the matching circuit patterns 3 are formed for example in four rows in the direction in which the insulating film 2 wound up onto the reel 25 is drawn out. Therefore, the communication characteristic test is performed in the following construction. Communication characteristic testers each comprising a measurement jig 41 for communication with each structure consisting of the matching circuit 3 and the chip 5 and a measurement circuit 42 connected electrically to the measurement jig 41 are arranged four to match the foregoing layout of structures. In this state, the insulating film 2 is drawn out from the reel 25 and four such structures as described above are arranged at positions where each structure comes into contact with two electrodes 43A and 43B of the measurement jig 41 in the associated communication characteristic tester. At this time, the structure does not contact the electrodes 43A and 43B directly but contacts them through the insulating film 2. That is, a so-called proximity connection is effected wherein the structure and the electrodes 43A, 43B are joined through a capacitance. In this state, a communication characteristic test is performed for the four structures at a time. The structure and the electrodes 43A, 43B are coupled together not by a radio wave but eletrocircuitwise (electrically), so that the communication characteristic test can be performed without taking into account the radio wave environment around a communication characteristic tester. Consequently, the test can be conducted even in a narrow place. Besides, since the test can be done for plural structures at a time, it is possible to build small-sized and high-speed fabrication equipment, especially small-sized and high-speed communication characteristic testing equipment.

The communication characteristic test is carried out by performing a series of steps described above for all the structures.

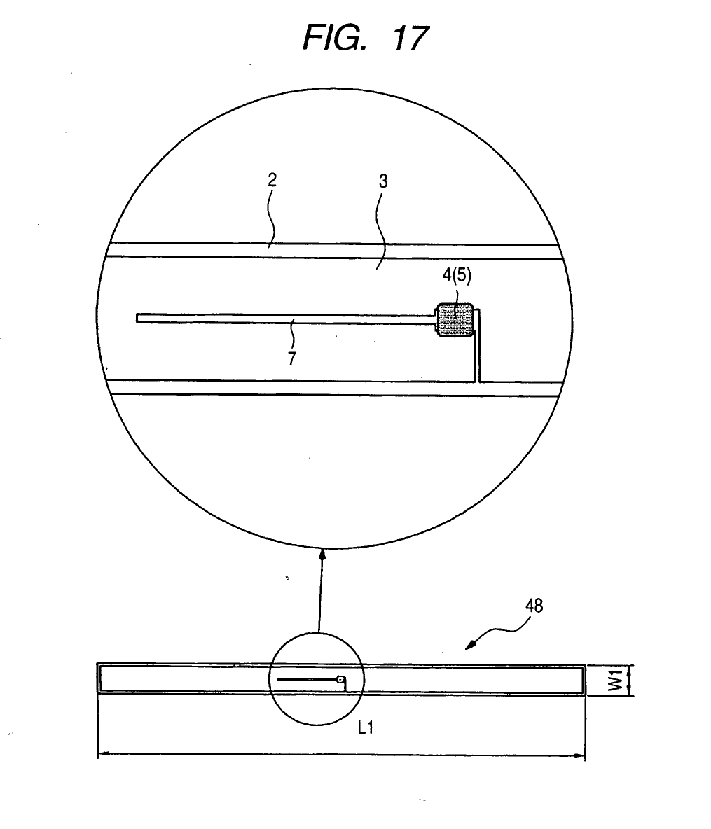

Next, a final number of the structures as non-defective products and that of defective products are checked (step P12). Subsequently, the insulating film 2 is cut into individual structures (step P13). In this connection, FIG. 17 is a plan view of a structure 48 obtained by the cutting step, in which the chip 5 and slit 7, as well as the vicinity thereof, are shown on a larger scale. For example, the structure 48 has a width W1 of about 2.375 mm and a length L1 of about 11 to 20 mm.

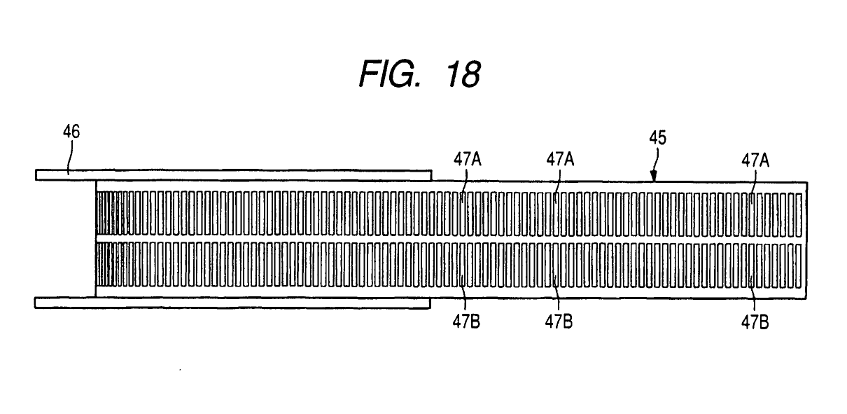

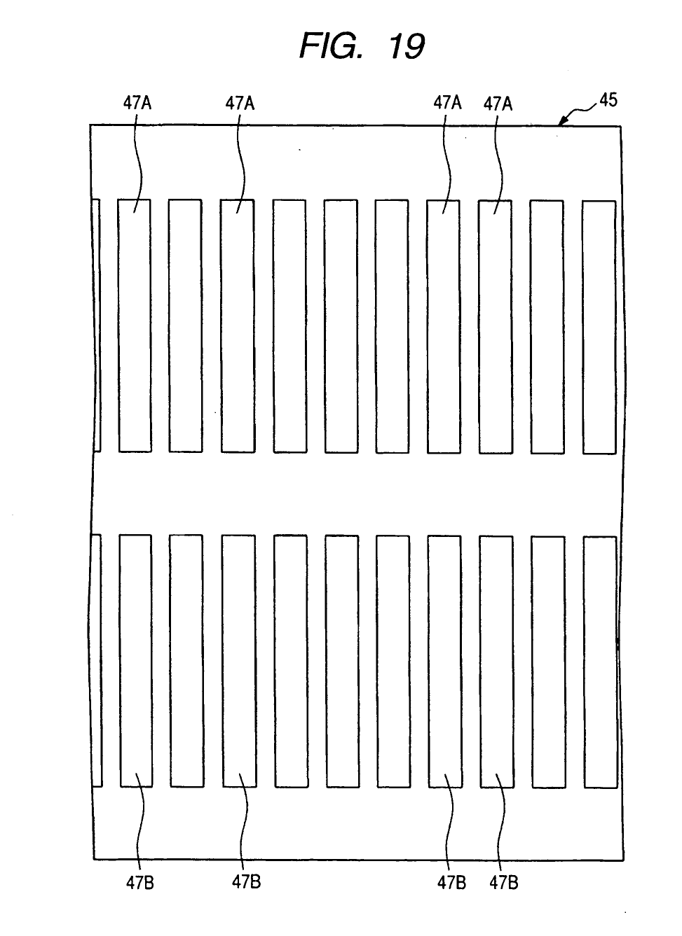

Next, a continuous tape-like insulating film for use in fabricating the antenna in the inlet of the first embodiment is provided (step P14). FIG. 18 is a plan view showing an insulating film 45 for use in fabricating the antenna in the inlet of the first embodiment and FIG. 19 is a plan view showing a part of FIG. 18 on a larger scale.

As shown in FIG. 18, a continuous tape-like insulating film (first insulator, second insulating film) 45 formed of polyethylene naphthalate for example, like the insulating film 2 (see FIGS. 2 and 3) described above, is loaded to the antenna fabrication process in a wound-up state onto a reel 46. A large number of antenna patterns (antennas) 47A and 47B are formed beforehand at predetermined intervals on one surface of the insulating film 45. In the same process as the process of forming the matching circuit patterns 3 (see FIGS. 2 and 3) described above the antenna patterns 47A and 47B can be formed by, for example, a thin Al film (first conductive film), but are not required to have such a dimensional accuracy as that of the slit 7 (see FIG. 3) in each matching circuit pattern 3.

In the case where the antenna patterns 47A, 47B and the matching circuit patterns 3 are formed integrally using the same material, the antenna patterns 47A and 47B must also be formed with a high machining accuracy equal to that required of the matching circuit patterns 3. That is, for only a limited portion (matching circuit patterns 3), the whole must be formed using an expensive material with a high dimensional accuracy, which may result in an increase of the inlet fabrication cost.

According to this first embodiment, as described earlier, the matching circuit patterns for which a high dimensional accuracy is required and the antenna patterns 47A, 47B not requiring a high dimensional accuracy are formed in separate processes using separate materials. Besides, in case of forming the matching circuit patterns 3 in four rows as in this first embodiment (see FIG. 2), the area of the matching circuit patterns 3 can be made about one-fourth of the total area of the antenna patterns 47A and 47B. As a result, the fabrication cost of the matching circuit patterns 3 can be reduced in comparison with the case where the antenna patterns 47A, 47B and the matching circuit patterns 3 are formed integrally using the same material. Moreover, since the antenna patterns 47A and 47B are formed by the insulating film 45 using a material of a low cost different from the material of the insulating film 2 which forms the matching circuit pattern 3, the fabrication cost can be reduced also with respect to the antenna patterns 47A and 47B. That is, the inlet fabrication cost can be reduced according to this first embodiment. Further, since the matching circuit patterns 3 are formed in plural rows (four rows), it is possible to increase the number of matching circuit patterns 3 capable of being obtained from a single (one lot) insulating film 2. Consequently, it is possible to decrease the total number of insulating films 2 used and hence possible to diminish the management labor for the insulating film 2.

The insulating film 45 is in conformity to the standard of film carrier tapes like the insulating film 2. By forming the antenna patterns 47A and 47 from Al foil and forming the insulating film from polyethylene naphthalate, like the matching circuit patterns 3, it is possible to reduce the inlet material cost in comparison with the case where the antenna patterns 47A and 47B a re formed from Cu foil and the insulating film 45 from polyimide resin.

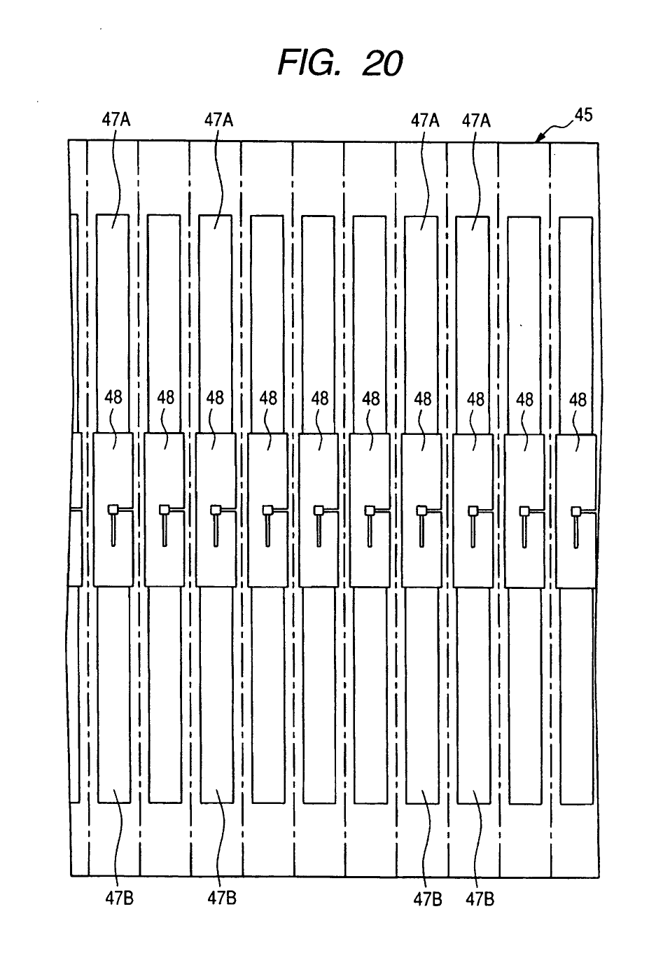

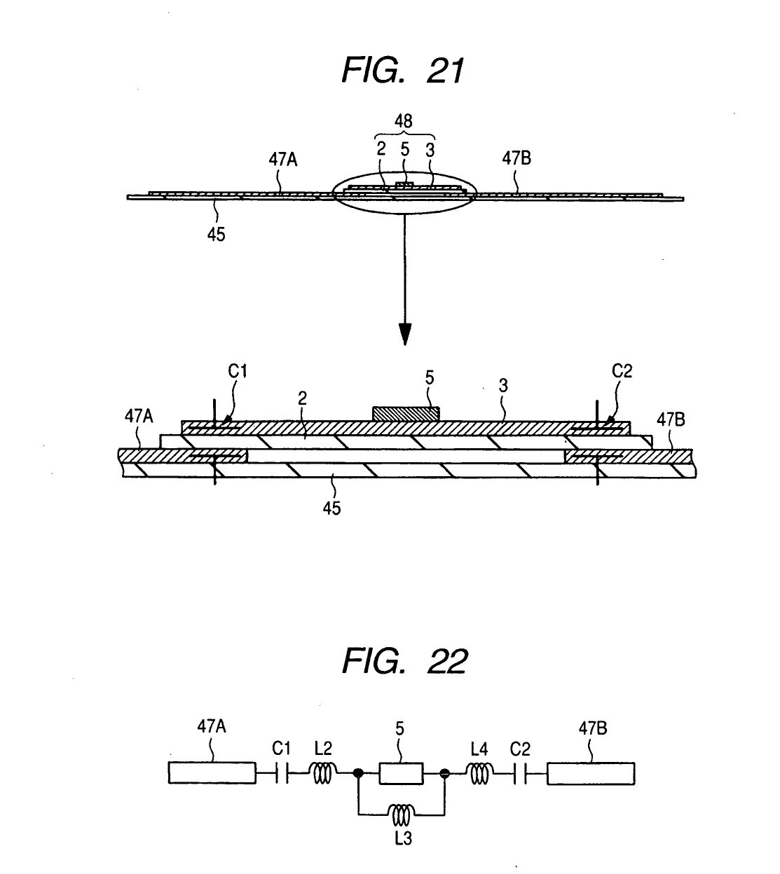

Next, as shown in FIG. 20, structures 48 formed through the above steps and each comprising a matching circuit pattern 3, a chip 5 and the insulating film 2 are bonded to the antenna patterns 47A and 47B using a resinous adhesive for example (step P15). In this case, as shown in FIG. 21, the structures 48 are each bonded so that the insulating film confronts the antenna patterns 47A and 47B. Thereafter, the insulating film 45 is cut along dot-dash lines shown in FIG. 20 (step P16) into individual inlets of the first embodiment and the inlets can be shipped (step P17).

As shown in FIG. 21, each structure 48 and the antenna patterns 47A, 47B are bonded together through the insulating film 2 which is a thin film. That is, each structure 48 and the antenna patterns 47A, 47B are not in direct contact with each other, but are electrically connected in proximity to each other through capacitances C1 and C2.

FIG. 22 illustrate a state of electric connections of various components which constitute the inlet of this first embodiment, including such a proximity connection. Each matching circuit pattern 3 forms inductances L2, L3 and L4 and matches the impedance between the chip 5 and the antenna patterns 47A, 47B. That is, the slit 7 formed in the matching circuit pattern 3 is formed in such a pattern as forming the inductances L2, L3 and L4 for matching between the impedance (first impedance) of the chip 5 and the impedance (second impedance) of the antenna patterns 47A, 47B.

In the inlet of this first embodiment fabricated as above, the matching circuit pattern 3 and the antenna patterns 47A, 47B are bonded together with an adhesive through the insulating film 2. Consequently, the matching circuit pattern 3 and the antenna patterns 47A, 47B can be bonded together easily in comparison with the case of using means for directly contacting and the matching circuit pattern 3 and the antenna patterns 47A, 47B with each other and bonding them by welding for example. As a result, it becomes possible to fabricate the inlet of this first embodiment in a short period and reduce the fabrication cost of the inlet.

Although in the above description the sets of antenna patterns 47A and 47B are formed in one row, if the antenna patterns 47A and 47B may be short, they may be formed in plural rows (e.g., two rows). Also in this case, the same type of a matching circuit pattern as that described above with reference to FIG. 18 may be bonded to the antenna patterns 47A and 47B. That is, even if the specification, e.g., dimensions, of the antenna patterns 47A and 47B changes, there may be used a structure of the same specification as above with respect to the structure including the insulating film 2, matching circuit pattern 3 and pitch 5. Consequently, it becomes possible to fabricate a variety of inlets by only changing the equipment for fabrication of the insulating film 45 including the antenna patterns 47A and 47B. As a result, it is possible to minimize the investment in the equipment for fabrication of the inlet of this first embodiment and hence possible to suppress an increase of the inlet fabrication cost. Accordingly, it becomes possible to meet the market demand for various-kinds small-lot production.

Although in this first embodiment a description has been given above about the case of forming and shipping the inlet, the long insulating film 2 may be shipped in its wound-up state onto the reel 25 after step P12 in compliance with a customer's request and the work of cutting the insulating film into individual structures each consisting of the insulating film 2, matching circuit pattern 3 and chip 5 and bonding each structure to the antenna patterns 47A and 47B may be done on the customer side. Or, the structures after cutting into individual structures may be shipped in compliance with a customer's request.

In the case where the mounting of the chip 5 onto the matching circuit pattern 3 is also performed on the customer side, the chip 5 alone is shipped. In this case, there is a fear that elements and circuits formed within the chip 5 may be damaged as a result of slight electric charging. On the other hand, according to this first embodiment, the resistance to electric charging can be improved because the chip 5 is shipped while being mounted on the matching circuit pattern 3 which is formed of metal.

### Second Embodiment

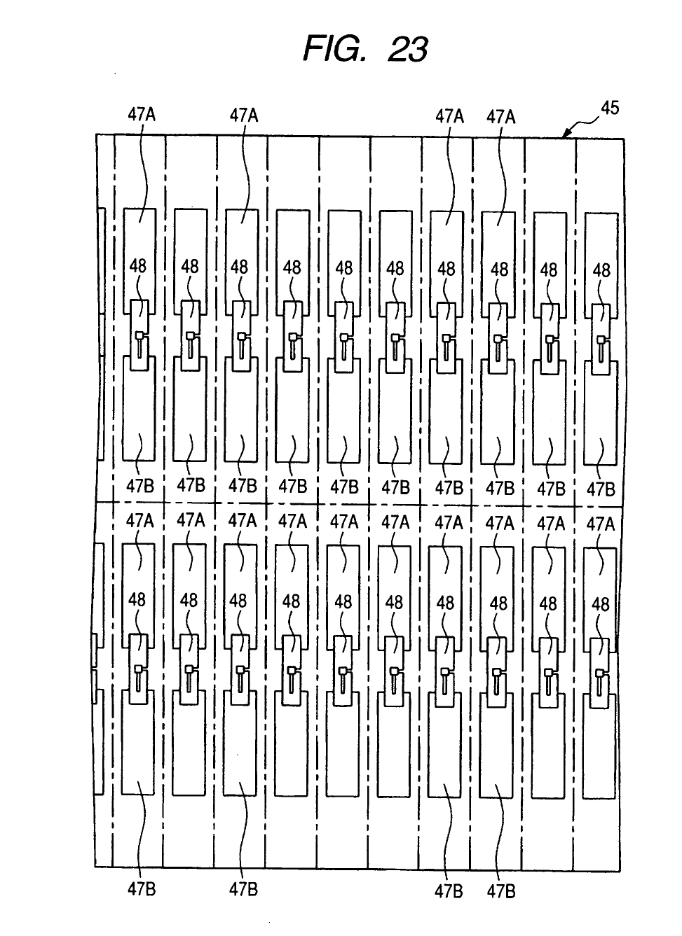

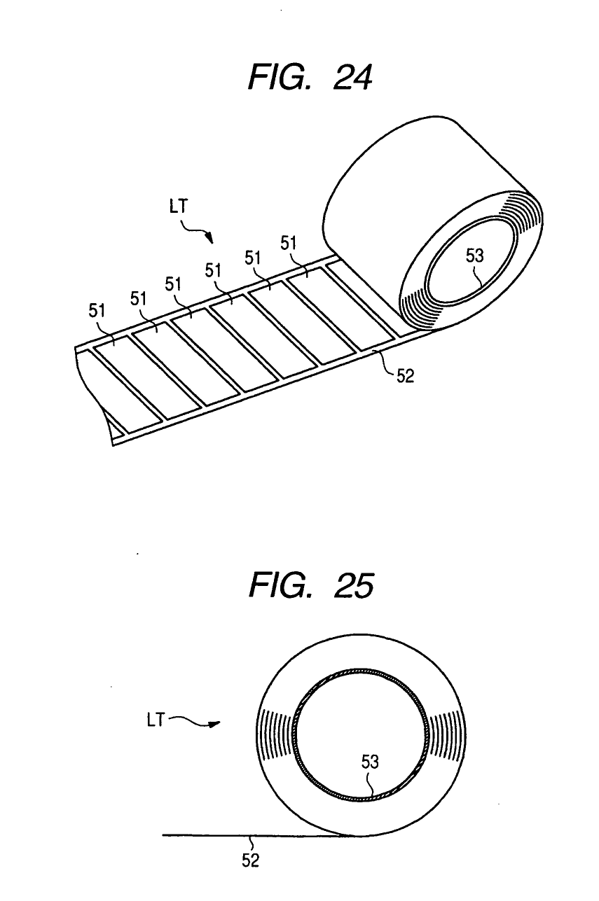

In this second embodiment the antenna patterns 47A and 47B described in the first embodiment are formed by another method. This second embodiment will be described below with reference to FIGS. 24 to 27. The steps up to step P13 (see FIG. 1) described in the first embodiment are also applied to this second embodiment.

An electronic tag of this second embodiment is a label seal type tag for example so that it can be used for commodity management by being affixed to the surfaces of commodities. FIGS. 24, 25 and 26 are a perspective view of a principal portion, a side view of a principal portion, and a plan view of a principal portion, respectively, of a label seal used in fabrication of the electronic tag of this second embodiment. As shown in FIGS. 24 to 26, a label seal (first insulator) 51 of this second embodiment is, for example, a paper label seal of a strong adhesion type which is commonly used. The label seal 51 has a label surface which is subjected to various printings or the like and an adhesive surface on the side-opposite to the label surface. Plural such label seals 51 are affixed continuously onto a continuous tape-like base paper 52 and the base paper 52 is fed as a label tape LT in a wound-up state onto a core 53.

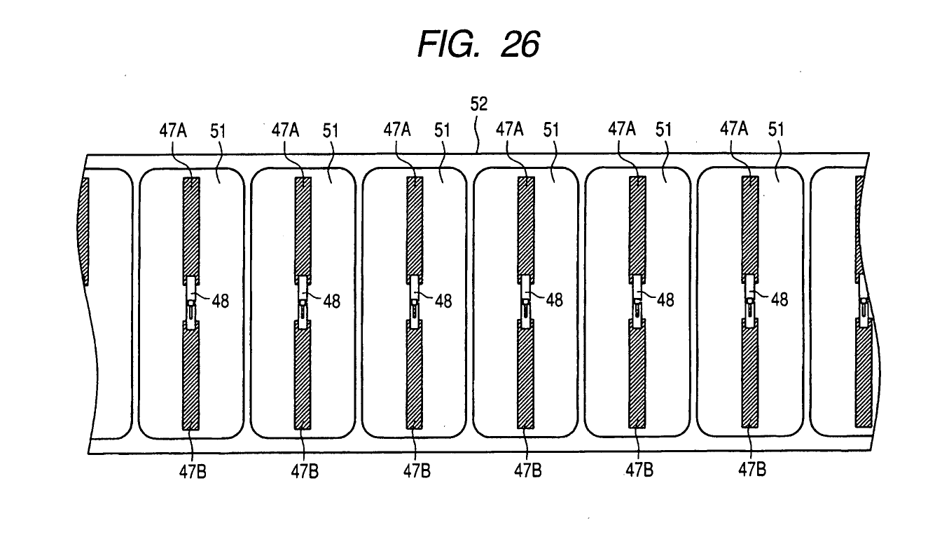

In this second embodiment, as shown in FIG. 26, antenna patterns 47A and 47B are formed on the label surface of each label seal 51. In this second embodiment the antenna patterns 47A and 47B can be formed, for example, by printing using a conductive ink or a plating transfer of a thin copper film onto the label surface of each label seal 51. In forming the antenna patterns 47A and 47B, even a material other than the conductive ink and thin copper film may be used insofar as it is a conductive material of about 10Ω or less. A structure 48 consisting of the matching circuit pattern 3 (see FIG. 17), chip 5 (see FIG. 17) and insulating film 2 (see FIG. 17) is bonded to the antenna patterns 47A and 47B in the same manner as in the first embodiment using, for example, a resinous adhesive and through the insulating film 2 to fabricate the electronic tag of this second embodiment. This bonding step is carried out while drawing out the base paper 52 with the label seal 51 affixed thereto from the core 53. The portion having been bonded completely can be wound up onto another core 53 or reel. After completion of the bonding process, the base paper 52 can be shipped in its wound-up state onto the core 53 or reel.

According to this second embodiment described above it is possible to omit the base film 45 which serves as the base material of the antenna patterns 47A and 47B used in the first embodiment. Moreover, since the electronic tag is completed upon bonding of the structure 48 to the antenna patterns 47A and 47B, the step of affixing the inlet to the tag can be omitted. Consequently, it is possible to reduce the fabrication cost of the electronic tag of this second embodiment and hence possible to reduce the cost of the electronic tag itself.

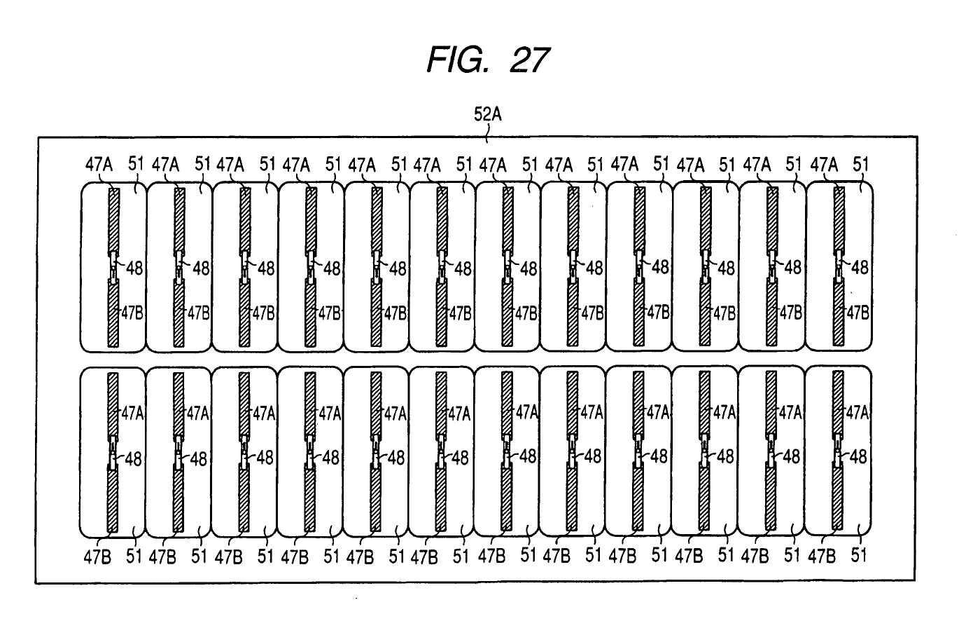

Although in the above embodiment a description has been given about the case where the label seals 51 used are affixed continuously to the continuous tape-like base paper 52, there may be used a single sheet-like base paper 52A with label seals 51 affixed thereto side by side, as shown in FIG. 27.

Also by this second embodiment it is possible to obtain the same effects as in the previous first embodiment.

### Third Embodiment

Next, a description will be given below about a third embodiment of the present invention.

An electronic tag of this third embodiment is a tag using paper as a base material and having a mode of use such that it is attached to a commodity with use of, for example, yarn, string or wire, thereby making it possible to effect commodity management.

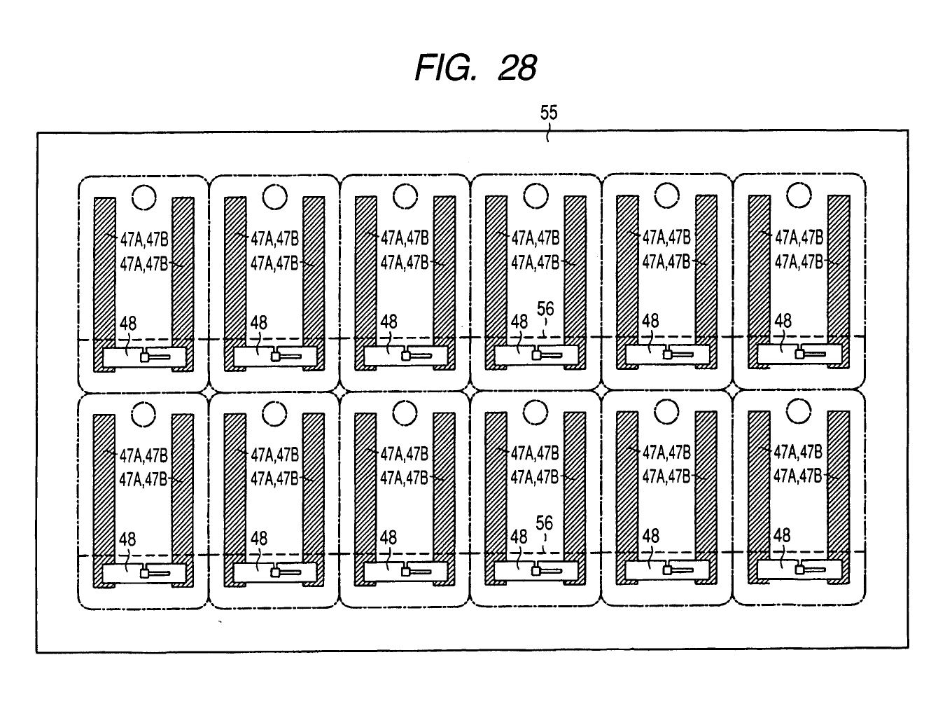

For forming the electronic tag of this third embodiment, first as shown in FIG. 28, a predetermined number of antenna patterns 47A and 47B are formed on the surface of paper (first insulator) 55 as a base material of the electronic tag. The antenna patterns 47A and 47B can be formed using the same means as in the previous second embodiment.

Next, structures 48 formed through the same steps as in the steps described in the first embodiment are bonded to the antenna patterns 47A and 47B through the insulating film 2 in the same way as in the first embodiment.

Next, perforations (broken line-like grooves) 56 are formed in the paper 55 at positions permitting separation between the antenna patterns 47A, 47B and the structures 48. In FIG. 28, the perforations 56 are formed in positions indicated by broken lines.

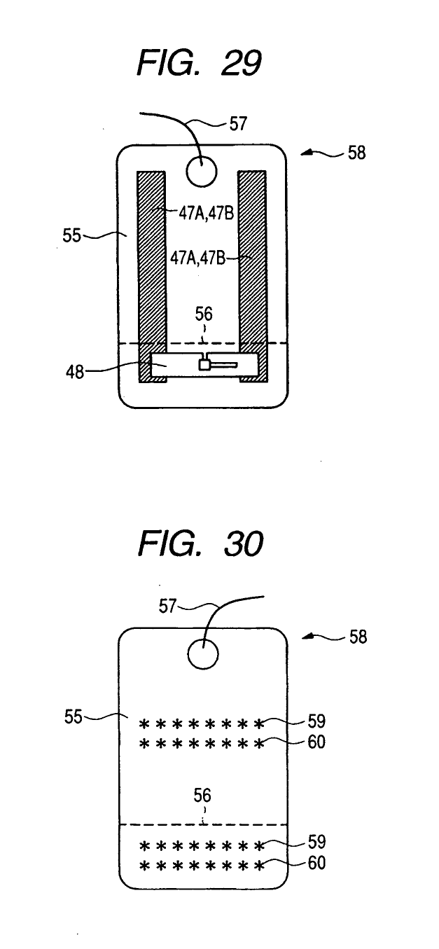

Then, the paper 55 is cut in a position corresponding to the outline of each electronic tag and a position where a string 57 is to be attached, to form individual tags and attach the string 57 or the like, thereby forming the electronic tag 58 according to this third embodiment shown in FIG. 29. In FIG. 28, the position corresponding to the outline of each electronic tag 58 and the position where the string 57 is to be attached are indicated by a dot-dash line. FIG. 30 illustrates a back side of each electronic tag 58 which side is opposite to the main surface where the antenna patterns 47A and 47B are formed. On the back side are printed a manufacturer's name 59 and a product name 60. The manufacturer's name 59 and the product name 60 may be printed before forming the antenna patterns 47A and 47B on the main surface of the paper 55 or may be added after completion of the electronic tag 58.

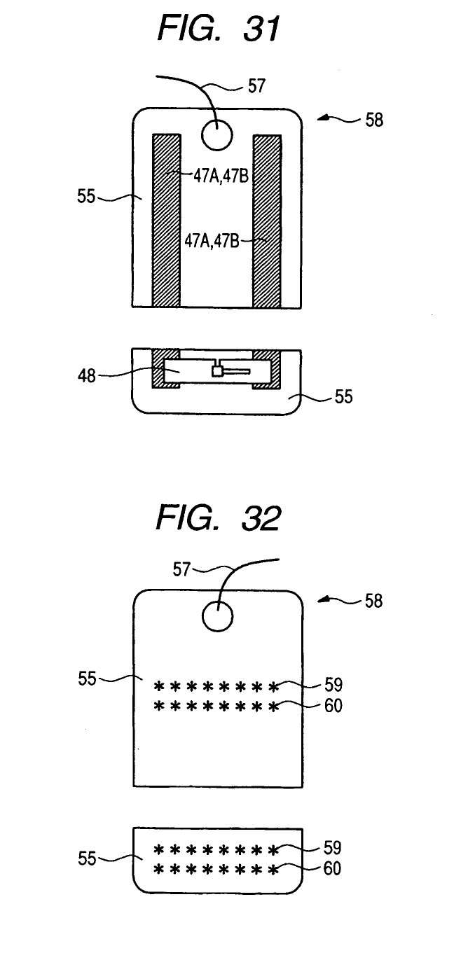

In the case where the electronic tag 58 of this third embodiment fabricated by the above process is used for example as a price tag of a commodity, the paper 55 can be cut easily into a non-communicable state along the perforations 56 (see FIGS. 31 and 32). Thus, it is possible to meet the demand for making the tag unemployable as an electronic tag at an appropriate time point from the standpoint of protection of personal data.

Also by this third embodiment described above it is possible to obtain the same effects as in the first and second embodiments.

### Fourth Embodiment

A fourth embodiment of the present invention will be described below.

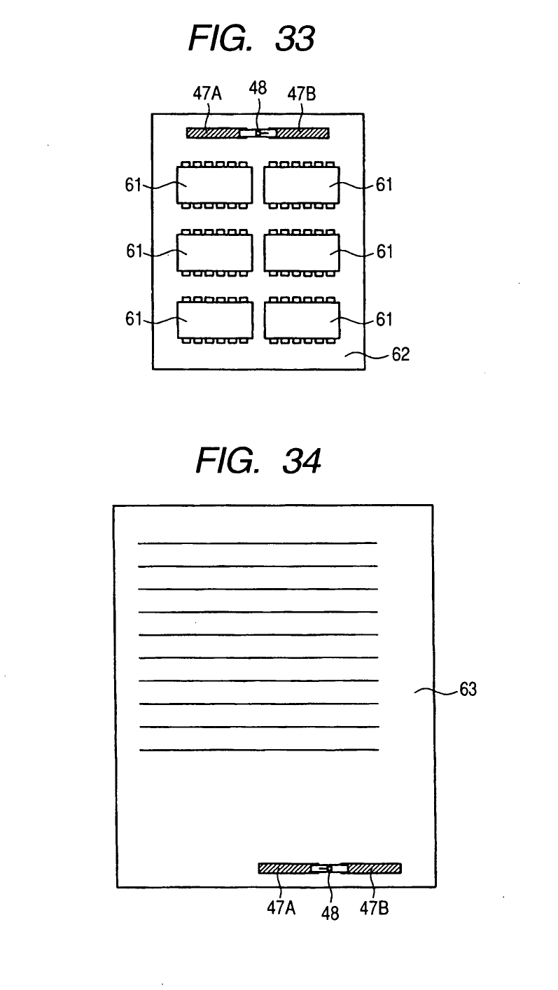

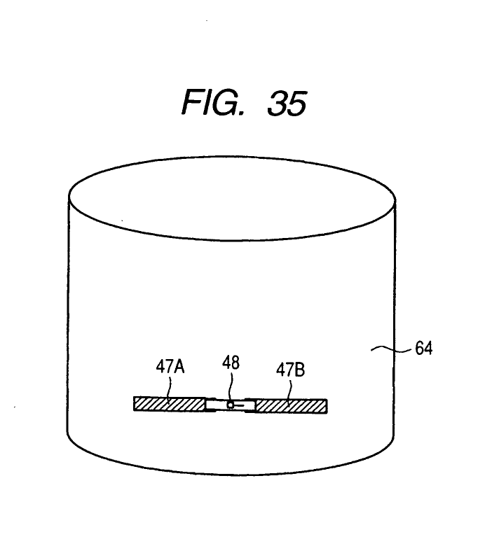

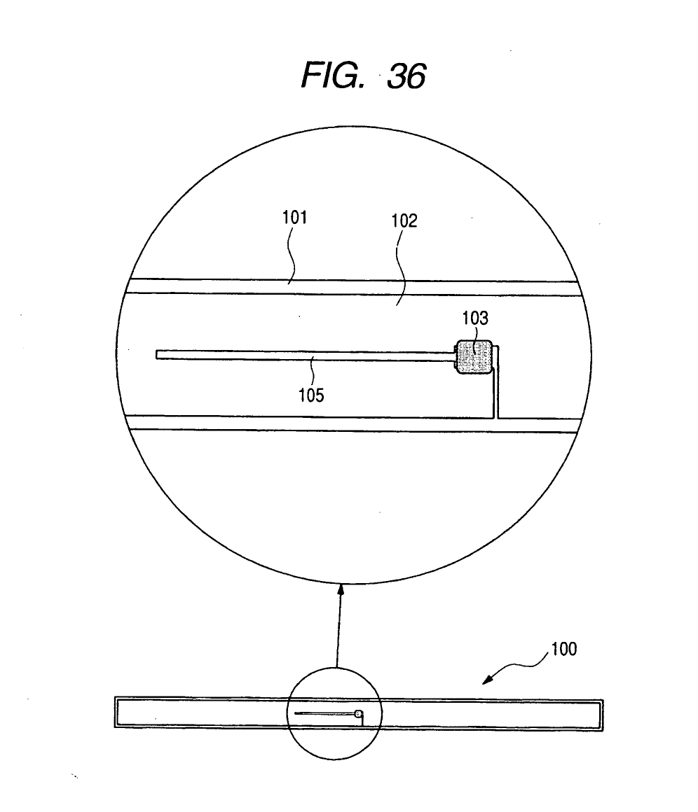

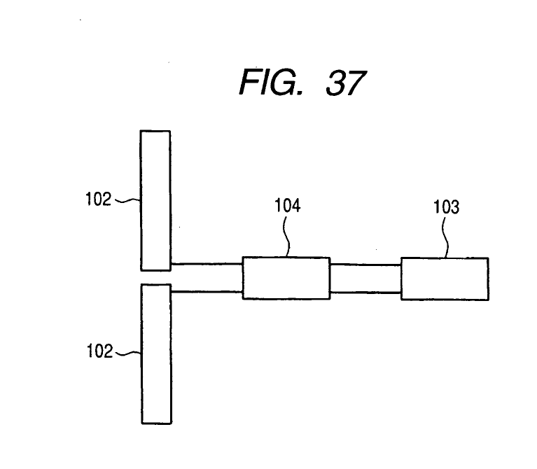

The electronic tag of this fourth embodiment has a form with product and structure incorporated therein such as, for example, a printed wiring board (first insulating, an object for mounting thereon of electronic devices) 62 with electronic devices, e.g., semiconductor packages 61 shown in FIG. 33, mounted thereon, a deed (first insulator) 63 shown in FIG. 34, and a plastic vessel (first insulator) 64 shown in FIG. 35. In this case, antenna patterns 47A and 47B are formed on the surfaces of such products and structures and the structures 48 (see FIG. 17) described in the first embodiment are bonded using for example a resinous adhesive through the insulating film 2 in the same manner as in the first embodiment. The antenna patterns 47A and 47B can be formed by such a method as printing using a conductive ink or plating transfer of a thin copper film as referred to in the second embodiment.

According to this fourth embodiment, since the electronic tag is incorporated in a commodity, structure, or the like, it is possible to omit the use of such base members as the insulating film 45 (see FIG. 20) shown in the first embodiment, label seal 51 (see FIG. 26) shown in the second embodiment and the paper 55 (see FIG. 29) shown in the third embodiment. Consequently, the electronic tag fabrication cost can be further reduced in comparison with the first to third embodiments.

Moreover, according to this fourth embodiment, since the electronic tag is incorporated in a commodity, structure, or the like, it is possible to certify that the product is a regular product and hence possible to easily distinguish it from an imitation.

Also by this fourth embodiment it is possible to obtain the same effects as in the first to third embodiments.

Although the present invention has been described above concretely by way of embodiments thereof, it goes without saying that the invention is not limited to the above embodiments, but that various changes may be made within the scope not departing from the gist of the invention.

Although in each of the above embodiments the antenna is formed using Al foil affixed to an insulating film which is formed of polyethylene terephthalate, for example the antenna may be formed using Cu foil affixed to one surface of the insulating film, or the insulating film may be formed of polyimide resin.

The electronic device and the fabrication method thereof according to the present invention are applicable for example to an inlet for an electronic tag and a fabrication process for the inlet.

What is claimed is:

1. An electronic device comprising:
a semiconductor chip;
an antenna formed by a first conductive film;
a matching circuit formed by a conductive film having a slit one end of which extends to an outer edge of the film, the matching circuit having the semiconductor chip mounted thereover and being connected electrically to the semiconductor chip and connected in proximity to the antenna through a first insulating film; and
resin which seals the semiconductor chip.

2. An electronic device according to claim 1, wherein the slit is formed by a pattern for matching a first impedance of the semiconductor chip and a second impedance of the antenna.

3. An electronic device according to claim 1, wherein the antenna is formed by the first conductive film patterned over a second insulating film.

4. An electronic device according to claim 1, wherein the antenna is formed by the first conductive film printed over a label seal, the label seal being affixed to base paper and having an adhesive surface opposed to the base paper and a label surface on the side opposite to the adhesive surface.

5. An electronic device according to claim 1, wherein the antenna is formed by the first conductive film printed over a paper tag, the tag having a broken line-like groove in a position permitting separation between the matching circuit and the antenna.

6. An electronic device according to claim 1, wherein the antenna is formed by the first conductive film printed over an object for mounting the electronic device thereover.

7. An electronic device comprising:
a semiconductor chip;
a matching circuit formed by a second conductive film having a slit one end of which extends to an outer edge of the film, the matching circuit having the semiconductor chip mounted thereover and being connected electrically to the semiconductor chip and connected in proximity to an antenna through a first insulating film; and
resin which seals the semiconductor chip.

8. An electronic device according to claim 7, wherein the slit is formed by a pattern for matching a first impedance of the semiconductor chip and a second impedance of the antenna.

9. A method of fabricating an electronic device, the electronic device comprising a semiconductor chip, an antenna formed by a first conductive film, and a matching circuit formed by a second conductive film having a slit one end of which extends to an outer edge of the film, the matching circuit having the semiconductor chip mounted thereover and being connected electrically to the semiconductor chip and connected in proximity to the antenna through a first insulating film, the method comprising the steps of:
(a) providing the antenna formed over a first insulator;
(b) providing the first insulating film, the first insulating film having a plurality of the matching circuits over a main surface thereof;
(c) mounting the semiconductor chip over each of the plural matching circuits and connecting the semiconductor chip and each of the matching circuits electrically with each other;
(d) sealing the semiconductor chip over each of the matching circuits with resin;
(e) after the steps (a) to (d), cutting the first insulating film to divide the plural matching circuits into individual circuits; and
(f) affixing the individual matching circuits to the antenna in such a manner that the first insulating film and the antenna are opposed to each other.

10. A method according to claim 9, wherein the slit is formed by a pattern for matching a first impedance of the semiconductor chip and a second impedance of the antenna.

11. A method according to claim 9,
wherein the first insulator is a continuous tape-like second insulating film, and
wherein the antenna is formed by forming a plurality of the first conductive films over a main surface of the second insulating film, and thereafter cutting the second insulating film into the individual first conductive films.

12. A method according to claim 9,
wherein the first insulator is a label seal affixed to base paper, the label seal having an adhesive surface opposed to the base paper and a label surface on the side opposite to the adhesive surface, and
wherein the antenna is formed by printing the first conductive film over the label surface of the label seal.

13. A method according to claim 12, wherein the first conductive film consists principally of a conductive ink or a plating transfer film.

14. A method according to claim 9,
wherein the first insulator is a paper tag,
wherein the antenna is formed by printing the first conductive film over the tag, and
wherein the tag is formed with a broken line-like groove in a position permitting separation between the matching circuit and the antenna.

15. A method according to claim 14, wherein the first conductive film consists principally of a conductive ink or a plating transfer film.

16. A method according to claim 9,
wherein the first insulator is an object for mounting thereover of the electronic device, and
wherein the antenna is formed by printing the first conductive film over the object.

17. A method according to claim 16, wherein the first conductive film consists principally of a conductive ink or a plating transfer film.

18. A method according to claim 9, wherein the matching circuit of a single specification is connected in proximity to the antenna of plural specifications.

19. A method of fabricating an electronic device, the electronic device comprising a semiconductor chip and a matching circuit formed by a second conductive film having a slit one end of which extends to an outer edge of the film, the matching circuit having the semiconductor chip mounted thereover and being connected electrically to the semiconductor chip and connected in proximity to an antenna through a first insulating film, the method comprising the steps of:
(a) providing the first insulating film, the first insulating film having a plurality of the matching circuits over a main surface thereof;
(b) mounting the semiconductor chip over each of the plural matching circuits and connecting the semiconductor chip and each of the matching circuits electrically with each other;
(c) sealing the semiconductor chip over each of the matching circuits with resin; and
(d) after the steps (a) to (c), shipping the plural matching circuits,
the step (d) including the step (d1) or (d2):
(d1) cutting the first insulating film to divide the plural matching circuits into individual circuits and shipping the individual circuits, or
(d2) shipping the plural matching circuits without cutting the first insulating film into individual matching circuits.

20. A method according to claim 19, wherein the slit is formed by a pattern for matching a first impedance of the semiconductor chip and a second impedance of the antenna.
